(19) United States
(12) Patent Application Publication
(10) Pub. No.: US 2005/0104821 A1
(43) Pub. Date: May 19, 2005

(54) Display arrangement

(75) Inventor: Steve Doe, Surrey (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/714,146

(22) Filed: Nov. 14, 2003

(51) Int. Cl. G09G 3/32

(52) U.S. Cl. 345/82

(57) ABSTRACT

A display arrangement comprising: a display comprising a plurality of pixels each of which is arranged to produce a respective output; at least a first light sensor for measuring the output of a first one of the plurality of pixels; and compensation means for receiving, from the first sensor, a first input indicative of a measured output of the first pixel and a second input indicative of a required output of the first pixel and for compensating an output control signal provided to the first pixel such that the output of the first pixel is substantially equal to the required output.

### TECHNICAL FIELD

Generally, embodiments of the present invention relate to a display arrangement having variable output efficiency. Particular embodiments relate to organic emissive displays having pixels with output efficiencies that vary differently.

### BACKGROUND OF THE INVENTION

Organic emissive displays use an organic thin-film that emits light when a current is passed through it. The efficiency of the thin film at converting electrical current to emitted light decreases gradually over time. One type of organic emissive display is an organic light-emitting diode (OLED) display. Another is a light emitting polymer (LEP) display.

Factors that may affect the efficiency of an organic thin film include how much it has been used, how much current it is driven with, the color of the emitted light, the humidity etc.

As the efficiency of an organic thin film may decrease with use, images may 25 become ‘burnt-in’ to the display. That is a darker ‘ghost’ of commonly displayed images may be visible in the display.

A color organic emissive display will have three different types of films. One will be used to form the red picture elements (pixels). One will be used to form the green pixels. One will be used to form the blue pixels. As the different films age differently, one or two of the colors may gradually dominate giving, for example, an image with too much green and not enough red and/or blue. Current research into these problems is directed towards improving the ‘life’ of the organic materials so that their efficiency decreases over much greater periods of use/time or not at all.

### BRIEF SUMMARY OF THE INVENTION

According to one embodiment of the invention there is provided a display arrangement comprising: a display comprising a plurality of pixels each of which is arranged to produce a respective output; at least a first light sensor for measuring the output of a first one of the plurality of pixels; and compensation means for receiving, from the first sensor, a first input indicative. of a measured output of the first pixel and a second input indicative of a required output of the first pixel and for compensating an output control signal provided to the first pixel such that the output of the first pixel is substantially equal to the required output.

According to another embodiment of the invention there is provided a display arrangement comprising: a display comprising a plurality of pixels arranged to produce separate brightness outputs from separately received respective drive currents including a first pixel having an efficiency that varies with use; and compensation means for receiving a first input indicative of the present efficiency of the first pixel and a second input indicative of a required brightness output of the first pixel and for compensating the magnitude of a first drive current provided to the first pixel such that the brightness output of the first pixel is substantially equal to the required brightness output.

According to another embodiment of the invention there is provided a method of controlling the output of a display comprising: providing an output control signal to a first pixel of the display; measuring light output from the first pixel; and compensating the output control signal provided to the first pixel to reduce the difference between the measured light output of the first pixel and the expected light output of the first pixel.

Embodiments of the invention may compensate overall for the effects of aging on display brightness. Embodiments of the invention may compensate for the effects of differential aging on pixel brightness. Embodiments of the invention may maintain color balance. Embodiments of the invention may prevent the ghosting of images.

A display arrangement includes a display by itself and, also, a display in combination with additional (unspecified) circuitry.

### BRIEF DESCRIPTION OF DRAWINGS

For better understanding of the present invention, reference will now be made by way of example only to the accompanying drawings in which:

FIG. 1 illustrates a portion of a prior art display;

FIG. 2 illustrates a compensated display according to one embodiment of the present invention; and

FIG. 3 illustrates a compensated display according to another embodiment of the present invention.

### DETAILED DESCRIPTION OF EMBODIMENT(S) OF THE INVENTION

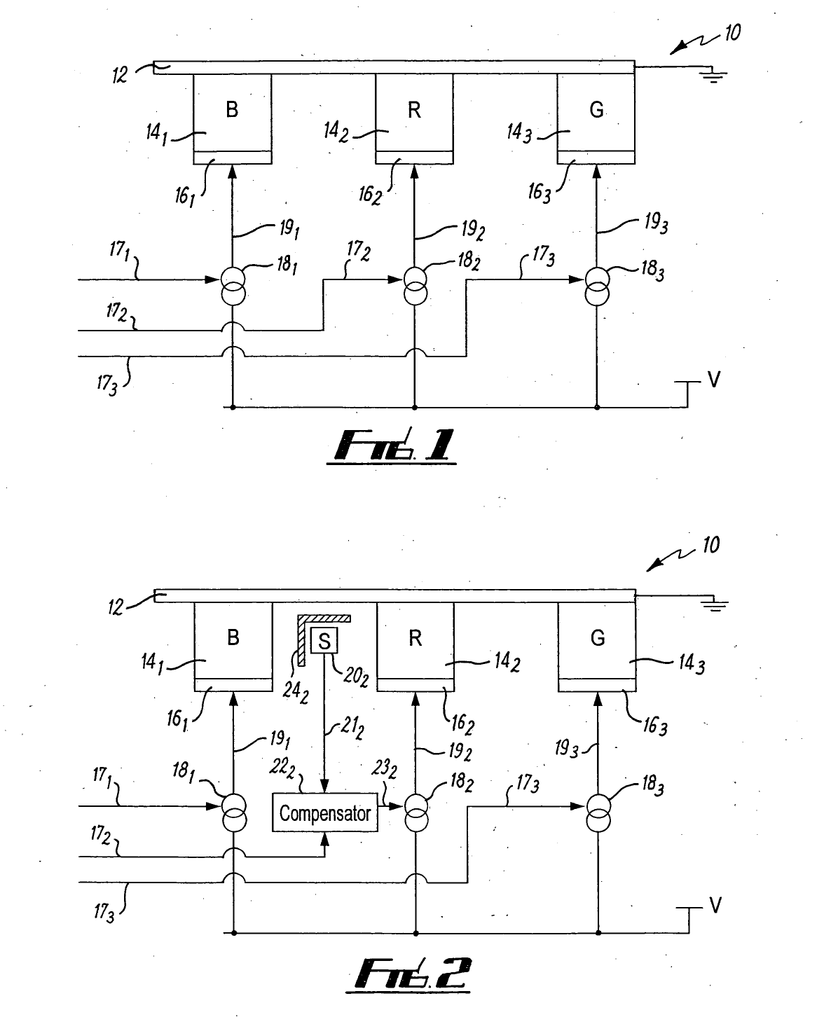

FIG. 1 schematically illustrates a portion of an organic emissive display 10. The display 10 includes a plurality of picture elements (pixels) 14. However, for clarity, the figure illustrates only three separate pixels 14₁, 14₂ and 14₃. In this example, each of the pixels 14 emits light of a different color. The pixel 14₁ emits blue light, the pixel 14₂ emits red light and the pixel 14₃ emits green light.

The organic emissive display 10 comprises an overlying common electrode 12 that is shared by the thin-film pixels 14₁, 14₂, and 14₃. Each of the pixels 14₁, 14₂ and 14₃ has a separate underlying respective pixel electrode 16₁, 16₂ and 16₃. Each of the pixel electrodes 16₁, 16₂ and 16₃ receives an input from a respective current driver 18₁, 18₂ and 18₃. The current drivers 18₁, 18₂ and 18₃ are constant current sources. The current driver 18₁ provides a drive current 19₁ to the pixel electrode 16₁ that is dependent upon a received output control signal 17₁. Typically the control signal will have one of predetermined plurality of voltages levels (grayscales). The current driver 18₂ provides a drive current 19₂ to the pixel electrode 16₂ that is dependent upon a received output control signal 17₂. The current driver 18₃ provides a drive current 19₃ to the pixel electrode 16₃ that is dependent upon a received output control signal 17₃.

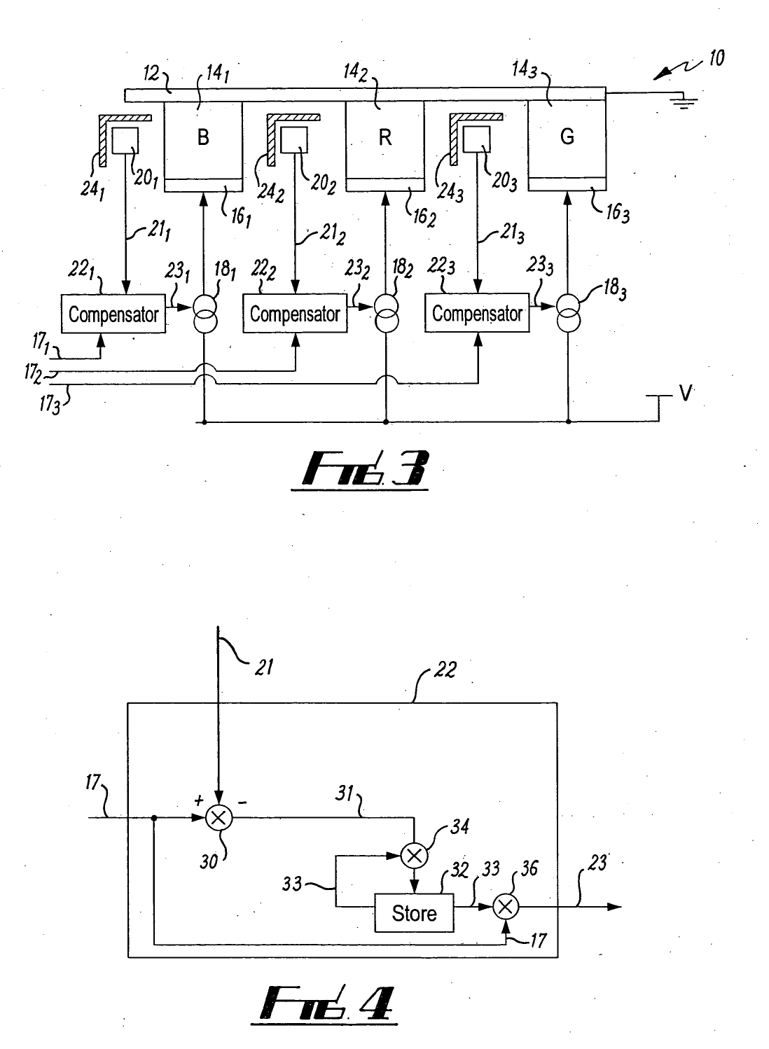

FIG. 2 illustrates a portion of a compensated organic emissive display 10. The illustrated compensated emissive display 10 differs from the emissive display 10 of FIG. 1 in that it has some additional components. Otherwise, it is similar and like reference numerals are used to denote like features.

The compensated organic emissive display 10 differs from the organic emissive display 10 of FIG. 1 in that the current driver 18₂ receives a compensated output control signal 23₂ and not the output control signal 17₂. Typically the output control signal 17₂. will have one of predetermined plurality of voltages levels (grayscales).The output control signal 17₂ is received by a compensator 22₂, which compensates that signal and provides the compensated output control signal 23₂ to the current driver 18₂. The compensator 22₂ also receives a measurement signal 21₂ from a light sensor 20₂. The light sensor 20₂ is positioned adjacent the pixel 14₂ and it measures the brightness of the light output from the pixel 14₂. A light shield 24₂ shields the light sensor 20₂ from light sources other than the pixel 14₂. Consequently, the measurement signal 21₂ is indicative to the brightness output of the pixel 14₂.

The compensator 22₂ varies the compensated output control signal 23₂ provided to the current driver 18₂ so that the brightness output of the pixel 14₂, as the efficiency as the pixel 14₂ varies, is substantially equal to that expected if the efficiency were invariant as a consequence of the output control signal 17₂.

As the efficiency of the pixel 14₂ varies, the brightness of its output without compensation is less than what the drive current 19₂ provided to the pixel electrode 16₂ would be expected to produce. Consequently, a greater compensated drive current 19₂ must be provided to the pixel electrode 16₂ to obtain the required brightness output from the pixel 14₂. This variation in the drive current 19₂ is achieved automatically by a feedback circuit that includes the pixel 14₂, its electrodes 12, 16₂, the light sensor 20₂, the compensator 22₂ and the current driver 18₂. As the efficiency of the pixel 14₂ decreases, the brightness of the light detected by the light sensor 20₂ decreases, consequently the value of the measurement signal 21₂ decreases, consequently the compensator 22₂ increases the compensated output control signal 23₂ provided to the current driver 18₂, consequently the compensated drive current 19₂ increases and the output brightness of the pixel 14₂ increases to that which is expected. Thus the measurement signal 212 provides gain control of the current driver 182.

FIG. 4 illustrates one example of a compensator 22 in more detail. If the luminance output (L) of a pixel 14 is in proportion to the drive current 19 (I) provided to the pixel 14, then the output characteristics of the pixel 14 can be represented as a L=k*I, where L is the luminance output, k is the efficiency of the pixel and I is the drive current provided to the pixel.

If the pixel 14 has an initial efficiency of k₁, then for an input current I the required luminance is k₁*I. However, as the efficiency of the pixel 14 decreases to k₂, the luminance output would become k₂*I. To obtain the required luminance of k₁*I, the current I has to be compensated by a factor of k₁/k₂ —the drive current becomes k₁*I /k₂. The ratio of k₁ to k₂ corresponds to the ratio of the expected luminance, in the absence of a decrease in efficiency, for drive current I to the actual luminance produced, as a consequence of a decrease in efficiency, by drive current I.

The measurement signal 21 corresponds to the contemporaneous actual luminance of the pixel 14 and the output control signal 17 corresponds to the required luminance. Typically the output control signal 17 will have one of predetermined plurality of voltages levels (grayscales). The measurement signal 21 is divided by the output control signal 17 by multiplier 30 to produce a contemporaneous factor signal 31. This factor signal 31 corresponds to the ratio representing a contemporaneous change in efficiency. It is multiplied in multiplier 34 with the cumulative factor 33 stored in a suitable storage device 32. The result replaces the cumulative factor 33 stored in the storage device 32. The storage device 32 may be a capacitor or other memory device. The updated cumulative factor 33 is provided to a multiplier 36 where it is combined with the output control signal 17 to produce the compensated output control signal 23. As the luminance output of the pixel 14 converges to the expected luminance output, the instantaneous factor signal 31 converges to 1 and the cumulative factor 33 remains constant. Thus, the compensated output control signal 23 is held at a value that maintains the luminance output of the pixel 14 at an expected value despite a decrease in its the efficiency of the pixel 14.

Although only three pixels are illustrated in FIG. 2, the compensated display would have many hundreds or thousands of pixels of each color. Although the Fig. illustrates only a feedback loop including a single light sensor 20₂ and single compensator 22₂, each of the red pixels could have their own corresponding feedback loop with light sensor and compensator.

Although, in the example of FIG. 2 the output of a red pixel is compensated, in other embodiments the outputs of differently colored pixels may be separately compensated instead of or in addition to the red pixels as illustrated in FIG. 3. Typically, those pixels that have a significant decrease in efficiency over their lifetime may be compensated.

FIG. 3 illustrates a portion of a compensated organic emissive display 10. The illustrated compensated emissive display 10 differs from the compensated organic emissive display 10 of FIG. 2 in that it has some additional components. Otherwise, it is similar and like reference numerals are used to denote like features.

The compensated organic emissive display 10 differs from the compensated organic emissive display 10 of FIG. 2 in that each of the blue pixel 14₁, the red pixel 14₂ and the green pixel 14₃ are compensated by their own feedback loop including a light sensor 20, compensator 22, current driver 18 and pixel 14.

The output control signal 17₁ for controlling the luminance of the blue pixel 14₁, is received by a compensator 22₁, which compensates that signal and provides the compensated output control signal 23₁ to the current driver 18₁. The compensator 22₁ also receives a measurement signal 21₁ from a light sensor 20₁. The light sensor 20₁ is positioned adjacent the blue pixel 14₁ and it measures the brightness of the light output from the blue pixel 14₁. A light shield 24₁ shields the light sensor 20₁ from light sources other than the pixel 14₁. Consequently, the measurement signal 21₁ is indicative to the brightness output of the pixel 14₁.

The compensator 22₁ varies the compensated output control signal 23₁ provided to the current driver 18₁ so that the brightness output of the blue pixel 14₁, as the efficiency as the pixel 14₁ varies, is substantially equal to that expected if the efficiency were invariant as a consequence of the output control signal 17₁. An example of a suitable compensator 22₁ is illustrated in FIG. 4.

The output control signal 17₂ for controlling the luminance of the red pixel 14₂ is received by a compensator 22₂, which compensates that signal and provides the compensated output control signal 23₂ to the current driver 18₂. The compensator 22₂ also receives a measurement signal 21₂ from a light sensor 20₂. The light sensor 20₂ is positioned adjacent the red pixel 14₂ and it measures the brightness of the light output from the pixel 14₂. A light shield 24₂ shields the light sensor 20₂ from light sources other than the pixel 14₂. Consequently, the measurement signal 21₂ is indicative to the brightness output of the pixel 14₂.

The compensator 22₂ varies the compensated output control signal 23₂ provided to the current driver 18₂ so that the brightness output of the pixel 14₂, as the efficiency as the pixel 14₂ varies, is substantially equal to that expected if the efficiency were invariant as a consequence of the output control signal 17₂. An example of a suitable compensator 22 is illustrated in FIG. 4.

The output control signal 17₃ for controlling the luminance of the green pixel 14₂ is received by a compensator 22₃, which compensates that signal and provides the compensated output control signal 23₃ to the current driver 18₃. The compensator 22₃ also receives a measurement signal 21₃ from a light sensor 20₃. The light sensor 20₃ is positioned adjacent the green pixel 14₃ and it measures the brightness of the light output from the pixel 14₃. A light shield 24₃ shields the light sensor 20₃ from light sources other than the pixel 14₃. Consequently, the measurement signal 21₃ is indicative to the brightness output of the pixel 14₃.

The compensator 22₃ varies the compensated output control signal 23₃ provided to the current driver 18₃ so that the brightness output of the pixel 14₃, as the efficiency as the pixel 14₃ varies, is substantially equal to that expected if the efficiency were invariant as a consequence of the output control signal 17₃. An example of a suitable compensator 22 is illustrated in FIG. 4.

Although only three pixels are illustrated in FIG. 3, the compensated display would have many hundreds or thousands of pixels of each color each with their own corresponding feedback loop with light sensor and compensator.

The above embodiments, describe how the output of an individual pixel can be individually compensated because of a variation in the efficiency of the pixel. These embodiments are most suitable for use in cases where the efficiency of each pixel varies in dependence upon the use of that individual pixel e.g. its prior use, its total luminance output, the number of times it has been cycled. Organic emissive materials, particularly those used to produce green and blue light have an efficiency that varies with use. These embodiments may also be used, but are sub-optimal, where the efficiency of each pixel varies in dependence upon only common factors such as the lifetime of the pixels and their color.

If the efficiency of each pixel varies in dependence upon only common factors such as the lifetime of the pixel and their color then a single feedback circuit of light sensor and compensator may be used to compensate simultaneously all the drive currents for pixels of the same color.

Although, the above embodiments describe color organic emissive displays, monochrome displays may be similarly compensated.

In the above embodiments, the organic emissive display 10 is typically actively driven with the transistors of the current driver 18 being integrated in the same substrate as the pixels 13, the electrodes 12, 16. The light sensors 20 may also be integrated in the substrate as phototransistors or photodiodes. The compensators 22 may also be integrated in the substrate or alternatively they may be positioned off the substrate. A disadvantage of positioning the compensators off the substrate is that there is an increase of the complexity of the interconnects to the display substrate. However, if the compensators are positioned off the substrate, they may be integrated into a single processor or circuit. The term ‘display arrangement’ is intended include a display for which compensation is determined at the display and also a display for which compensation is determined off the display in combination with the circuitry off-display that performs the determination. Although embodiments of the present invention have been described in the preceding paragraphs with reference to various examples, it should be appreciated that modifications to the examples given can be made without departing from the scope of the invention as claimed. For example, the compensator shown in FIG. 4 is illustrative and other designs of compensators may be used.

1. A display arrangement comprising:
a display comprising a plurality of pixels each of which is arranged to produce a respective output;
at least a first light sensor for measuring the output of a first one of the plurality of pixels; and
compensation means for receiving, from the first sensor, a first input indicative of a measured output of the first pixel and a second input indicative of a required output of the first pixel and for compensating an output control signal provided to the first pixel such that the output of the first pixel is substantially equal to the required output.

2. A display arrangement as claimed in claim 1, comprising a feedback loop including the compensation means, the first sensor for providing the first input to the compensation means, the first pixel for providing the second input to the compensation means, and a driver for receiving an input from the compensation means and for providing the output control signal to the first pixel.

3. A display arrangement as claimed in claim 1, wherein the display comprises a plurality of pixels including at least a first multiplicity of pixels of a first type including the first pixel and a second multiplicity of pixels of a second type, and further comprising:
at least a second light sensor for measuring the output of a first one of the plurality of pixels of the second type; and
compensation means for receiving, from the second sensor, a first input indicative of a measured output of the first pixel of the second type and a second input indicative of a required output of the first pixel of the second type and for compensating an output control signal provided to the first pixel of the second type such that the output of the first pixel of the second type is substantially equal to the required output.

4. A display arrangement as claimed in claim 1, wherein the display comprises a plurality of pixels including at least a first multiplicity of pixels of a first type and a second multiplicity of pixels of a second type, and further comprising:
at least a first multiplicity of light sensors, wherein each of the first multiplicity of light sensors is associated with a pixel of the first type; and
compensation means, for each pixel of the first type, for receiving from the light sensor associated with the respective pixel a first input indicative of a measured output of the respective pixel and a second input indicative of a required output of the respective pixel and for compensating an output control signal provided to the respective pixel such that the output of the respective pixel is substantially equal to the required output.

5. A display arrangement as claimed in claim 4, comprising a feedback loop for each of the first multiplicity of pixels, wherein each feedback loop includes compensation means, a light sensor and a pixel of the first type.

6. A display arrangement as claimed in claim 4, wherein the pixels of the first and second type comprise different photo-emissive materials.

7. A display arrangement as claimed in claim 4, wherein the pixels of the first type emit red or blue colored light.

8. A display arrangement as claimed in claim 1, wherein the first pixel has a variable efficiency.

9. A display arrangement as claimed in claim 8, wherein the efficiency decreases with use.

10. A display arrangement as claimed in claim 4, wherein pixels of the first type and the pixels of the second type have differently variable efficiencies.

11. A display arrangement as claimed in claim 10, wherein the differently variable efficiencies decrease at different rates with use.

12. A display arrangement as claimed in claim 4, wherein each of the multiplicity of pixels of the second type do not have associated light sensors.

13. A display arrangement as claimed in claim 1, further comprising:
a plurality of light sensors, wherein each of the plurality of pixels is associated with a light sensor; and
compensation means, for each pixel, for receiving from the light sensor associated with the respective pixel a first input indicative of a measured output of the respective pixel and a second input indicating a required output of the respective pixel and for compensating an output control signal provided to the respective pixel such that the output of the respective pixel is substantially equal to the required output.

14. A display arrangement as claimed in claim 1, wherein the compensated output control signal corresponds to an output control signal multiplied by the ratio of the required output of the first pixel to the output of the first pixel in response to the output control signal.

15. A display arrangement as claimed in claim 1, wherein the first light sensor measures the brightness output of the first pixel.

16. A display arrangement as claimed in claim 1 wherein the first light sensor is integrated into the display.

17. A display arrangement as claimed in claim 16 wherein the first light sensor is positioned adjacent the first pixel.

18. A display arrangement as claimed in claim 17, wherein a light shield for the first light sensor is integrated in the display.

19. A display arrangement as claimed in claim 16 wherein the compensation means is integrated into the display.

20. A display arrangement as claimed in claim 1 wherein the display is an organic emissive display.

21. A display arrangement comprising:
a display comprising a plurality of pixels arranged to produce separate brightness outputs from separately received respective drive currents including a first pixel having an efficiency that varies with use; and
compensation means for receiving a first input indicative of the present efficiency of the first pixel and a second input indicative of a required brightness output of the first pixel and for compensating the magnitude of a first drive current provided to the first pixel such that the brightness output of the first pixel is substantially equal to the required brightness output.

22. A display arrangement further comprising at least a first sensor for measuring the brightness output of the first pixel, wherein the first input indicative of the present efficiency of the first pixel is an input, from the first sensor, indicative of a contemporaneously measured brightness output of the first pixel.

23. A method of controlling the output of a display comprising:
providing an output control signal to a first pixel of the display;
measuring light output from the first pixel; and
compensating the output control signal provided to the first pixel to reduce the difference between the measured light output of the first pixel and the expected light output of the first pixel.
